(19) United States
(12) Patent Application Publication
(10) Pub. No.: US 2026/0127862 A1
(43) Pub. Date: May 7, 2026

(54) MULTIMODAL LLM CONTROLLER FOR AUTONOMOUS DRIVING CORNER CASES

(71) Applicant: NEC Laboratories America, Inc., Princeton, NJ (US)

(72) Inventors: Sparsh Garg, Fremont, CA (US); Manmohan Chandraker, Santa Clara, CA (US); Xu Cao, Urbana, IL (US)

(21) Appl. No.: 19/381,106

(22) Filed: Nov. 6, 2025

Related U.S. Application Data
(60) Provisional application No. 63/717,476, filed on Nov. 7, 2024.
(60) Provisional application No. 63/719,691, filed on Nov. 13, 2024.

(51) Int. Cl. G06V 10/774; G06T 11/60; G06V 10/25; G06V 10/776; G06V 20/56

(52) U.S. Cl. CPC G06V 10/774; G06T 11/60; G06V 10/25; G06V 10/776; G06V 20/56

(57) ABSTRACT

Systems and methods for identifying an issue in an input image displayed on a user interface, the issue being a visual depiction of an aspect of the input image that training data used for training a model does not have sufficient training on, having sufficient training includes the model reaching a performance threshold in response to testing the model on the issue and generating a natural language description of the issue. The systems and methods further include generating a set of simulated images from the natural language description that reflect one or more variations of the issue, selecting one or more training images to provide selected one or more training images from the set of simulated images, the selected one or more training images increasing the one or more variations of the issue in the training data, and training the model using the selected one or more training images.

### RELATED APPLICATION INFORMATION

This application claims priority to U.S. Provisional Patent Application No. 63/717,476, filed on Nov. 7, 2024, and U.S. Provisional Patent Application No. 63/719,691, filed on Nov. 13, 2024, both incorporated herein by reference in their entirety.

### BACKGROUND

### Technical Field

The present invention relates to synthetic training data generation for artificial intelligence models and more particularly applying a multimodal large language model to generate training data of corner cases for autonomous vehicle driving scenario training.

### Description of the Related Art

The majority of current autonomous systems, such as autonomous vehicles (AV), rely on modular-based architectures that combine components for perception, prediction, and planning to navigate driving scenarios. These systems face considerable challenges when dealing with rare and unpredictable “corner cases” that emerge in real world driving scenarios. These corner cases include encountering unusual objects such as, e.g., animals on the road, adverse weather conditions, unexpected events like accidents and downed powerlines, vehicle malfunctions such as brake failure, unpredictable traffic such as emergency vehicles, or external events such as falling objects. In other words, corner cases can include situations that are difficult to anticipate and react to, which can come from their rarity and corresponding lack of presence in training data, or bias from events or situations not contemplated when developing the training data.

Traditional self-driving systems struggle to generalize open domains, especially when encountering real-world corner cases. Collecting data on these scenarios such as, e.g., accidents and extreme weather conditions, can be helpful for autonomous vehicle training and enhance system performance but can be difficult or impossible to document in some situations.

Some works have proposed developing on-road accident detection and anticipation datasets. However, these datasets lack object-level risk annotations, making recognizing risky traffic agents difficult. Simulation tools have also been adopted to alleviate this problem by augmenting the datasets. Unfortunately, synthetic data may not always accurately capture the distribution of real driving scenes, and the tools can be difficult to control.

### SUMMARY

According to an aspect of the present invention, a method is provided for augmenting training data. The method includes identifying an issue in an input image displayed on a user interface, the issue being a visual depiction of an aspect of the input image that training data used for training a model does not have sufficient training on, having sufficient training includes the model reaching a performance threshold in response to testing the model on the issue and generating a natural language description of the issue. The method further includes generating a set of simulated images from the natural language description that reflect one or more variations of the issue, selecting one or more training images to provide selected one or more training images from the set of simulated images, the selected one or more training images increasing the one or more variations of the issue in the training data, and training the model using the selected one or more training images.

According to another aspect of the present invention, a system is provided for augmenting training data. The system includes a processor and a memory storing computer-readable instructions. When the computer-readable instructions are executed by the processor, the instructions cause the system to identify an issue in an input image displayed on a user interface, the issue being a visual depiction of an aspect of the input image that training data used for training a model does not have sufficient training on, having sufficient training includes the model reaching a performance threshold in response to testing the model on the issue and generate a natural language description of the issue. The memory also causes the processor to generate a set of simulated images from the natural language description that reflect one or more variations of the issue, select one or more training images to provide selected one or more training images from the set of simulated images, the selected one or more training images increasing the one or more variations of the issue in the training data, and train the model using the selected one or more training images.

According to yet another aspect of the present invention, a computer program product including a non-transitory computer-readable storage medium containing computer program code, the computer program code when executed by one or more processors causes the one or more processors to perform operations. The computer program code includes instructions to identify an issue in an input image displayed on a user interface, the issue being a visual depiction of an aspect of the input image that training data used for training a model does not have sufficient training on, having sufficient training includes the model reaching a performance threshold in response to testing the model on the issue and generate a natural language description of the issue. The computer program code also includes instructions to generate a set of simulated images from the natural language description that reflect one or more variations of the issue, select one or more training images to provide selected one or more training images from the set of simulated images, the selected one or more training images increasing the one or more variations of the issue in the training data, and train the model using the selected one or more training images.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level system for generating augmented training data, in accordance with an embodiment of the present invention;

FIG. 2 is a block diagram illustrating a system for augmenting training data shown in greater detail, in accordance with an embodiment of the present invention;

FIG. 3 is a schematic diagram illustrating iteratively generating images for augmented data shown in greater detail, in accordance with an embodiment of the present invention;

FIG. 4 is schematic diagram of an image generation module, in accordance with an embodiment of the present invention;

FIG. 5 is a pseudocode illustrating an algorithm used to generate an image, in accordance with an embodiment of the present invention;

FIG. 6 is a block diagram illustrating images that can be used to train a model, in accordance with an embodiment of the present invention;

FIG. 7 is a flow diagram illustrating a method for augmenting training data, in accordance with an embodiment of the present invention; and

FIG. 8 is a schematic diagram illustrating a system for executing data augmentation, in accordance with an embodiment of the present invention.

### DETAILED DESCRIPTION OF PREFERRED EMBODIMENTS

Artificial intelligence (AI) can be tasked with recommending and performing actions in the physical world, these actions can be in fields such as computer vision and autonomous driving/vehicles (AV), though the other forms of AI are also contemplated. The real-world often relies on several heuristics that are often, but not always true. In the instances these heuristics are not true (e.g., edge/corner cases) predicting next actions can be difficult for a user or model. Corner cases can be edge cases or multi-constraint edge cases. To put this another way, edge cases can be rare occurrences like uncommon objects in images, and corner cases can be rare occurrences with multiple factors such as different lighting or surroundings. In accordance with an embodiment of the present invention training for these unusual situations can be useful for a model to more accurately simulating a user response, handle a situation more appropriately, reduce time, money, and other resources developing training data, and develop a more robust model.

Advancements in generative models for text-to-image scene generation have opened new possibilities for augmenting training data for autonomous driving simulations and other purposes, especially in generating scenarios that are difficult to collect in real-world settings, but controlling the model has been challenging when developing these scenarios. Control over scene elements, such as, e.g., object types, locations, sizes, etc., is preferred to ensure the generated scenarios match scene requirements and cover a wide variety of domains/situations. Requirements can include dataset requirements and user requirements. Dataset requirements can be related to real (e.g., possible, plausible, probable) simulated corner case images and user requirements can be related to following user instructions (e.g., including the risk features) seeking to be captured. Current text-to-image models often introduce excessive variability, generating scenes that do not always align with user specifications, especially the extreme corner cases. Excessive variability can also modify too many factors at once and make training the model on a given corner case difficult. Further, current model training methods can fail to accurately capture the detailed instructions provided in the prompts, leading to inconsistencies.

To address these challenges, in accordance with an embodiment of the present invention a multimodal large language model (MLLM) controller which can guide a diffusion-based image editing pipeline is introduced. The pipeline ensures alignment between the generated corner case scenarios and user requirements. The MLLM controller can include a background image selection component, an LLM-controlled layout generation component, and a multi-turn image editing component which includes MLLM feedback learning. The background image selection component can choose background images that serve as inputs for generating corner case images and can introduce background related corner cases like extreme weather and night scenes into the output image. The LLM-controlled layout component extracts the bounding box of all traffic-related objects in the selected images from the background image selection component. Multi-turn image editing component then enhances these corner case images through a multi-step, layout-guided, feedback-controlled denoising diffusion process which enables the automatic creation of realistic corner case scenarios.

The MLLM controller iteratively monitors and adjusts the scene layout during each generation round. According to some embodiments of the present invention, the layout can include the shape, position, and color of objects in the scene. After each iteration, an MLLM evaluator compares the generated scene to the original prompt. This can be done by analyzing bounding boxes and comparing objects detected in the image with main corner case objects and checking for alignment with user expectations. If user expectations are not met, then the MLLM modifies the background scene until they are. The MLLM can check and align the generated image with the user text based prompt. If all features are included and the image meets the dataset requirements (e.g., is real enough), the MLLM can determine that the user expectations are met. A score (e.g., performance threshold) can be developed and compared to this effect. By evaluating the MLLM against a predetermined performance, the MLLM can know when to terminate data augmentation since sufficient augmentation has occurred and that the expectations for the augmentation are met. The score can be an aggregation of multiple factors.

The performance threshold can be set to determine whether an objective for the MLLM is achieved. If the MLLM performs worse than the performance threshold on a given metric/task/etc., then the data augmentation can continue, indicating the model still needs more or better variation on the augmented image to properly handle the situation (issue) depicted in the image. When the model performs to the level of, or better than the performance threshold for some task/metric/etc., (e.g., ability to identify an issue, ability to handle the issue properly, etc.), then the augmentation of the data can terminate. This can allow the model to be good enough on a single issue without spending too much time, money, computational resources, etc., on a given task if the model has a satisfactory amount of training or training data on the issue. The augmented images can be selected to augment the original training data to include variations of the issue. There can be particular methodologies of selecting variations such as, e.g., a set number of images with the same varied aspect. For example, an image depicting a situation with a bear can show five images of a bear at dawn, another five during the middle of the day, another five at night. Alternative ways to vary and determine variations are also contemplated.

When the generated scene aligns closely with the requirements, both the scene description and corresponding prompt-layout pairs are stored in a retrieval augmented database and then used as system prompts for the MLLM controller when simulating similar corner cases. The RAG database can be a third-party database such as ChromaDB™. When the generated scene does not align with the requirements, an MLLM evaluator provides the MLLM controller with feedback to guide the layout editing and hyperparameter tuning for the next round of generation. Aspects of the present invention can employ visual (video) language models in combination with, or alternative to, MLLMs or LLMs.

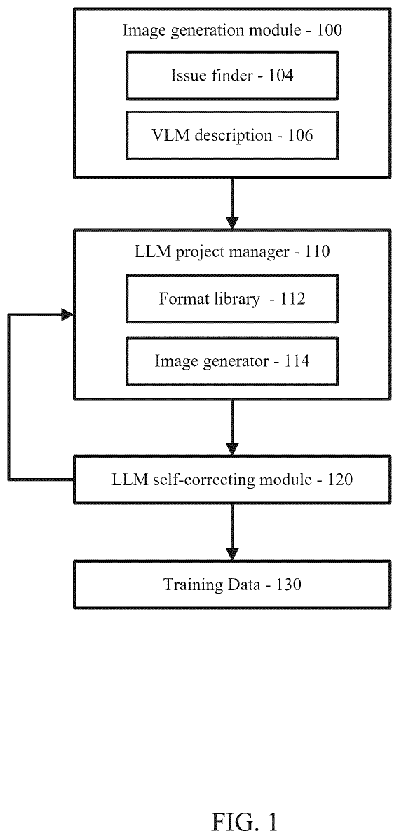

Referring now in detail to the figures in which like numerals represent the same or similar elements, and initially to FIG. 1, a system for generating images for MLLM learning of autonomous driving corner cases is illustrated in accordance with an embodiment of the present invention. Image generation module 100 (background image selection component) produces realistic details from actual driving scenarios so that the layout adjustments for alternative driving scenarios have a suitable initial scene. The layout adjustments for the background can include changing the type of motorway (e.g., highway, country road, city street, etc.), congestion on the road with other vehicles, lighting, distance from the issue (e.g., how much distance and time is there to react to the issue), lighting/time of day/visibility, haziness/fog/obstructed views from the sun, etc.

Other considerations can be less apparent such as e.g., the location of the original or generated image which can dictate driving laws, rules and regulations, and driver habits and expectations, turning indicator and other vehicle light habits, and horn habits. For example, pictures assumed to have been taken in a country that drive on the left side of the road can be augmented to create training data for countries that drive on the right side of the road. In other words, image generation module 100 creates details so that images created downstream for training data are useful for learning autonomous driving situations rather than implausible scenarios.

Issue finder 104 reviews images and when an unusual driving case is identified in an input image, a context output is generated to trigger downstream components. An unusual driving case can include “there is a black bear on the road” or “a car hit a streetlight.” Issue finder 104 can take images or videos as input to determine issues that can be simulated with variations. Issue finder 104 can be a vision language model. An image or video is the input and issue finder 104 will caption the input and output potential risk in the image or video. If the potential risk like a potential accident does not exist, issue finder 104 will not output anything

Image generation module 100 then searches existing autonomous driving databases for similar images that match the described issue from issue finder 104. The closest matching background image(s) is then selected. The database can be a retrieval augmented generation (RAG) database. Issue finder 104 also forms a text version of the issue. Issue finder 104 can use contrastive language image pretraining (CLIP) to encode the image and text for downstream processing. In other words, issue finder 104 reviews the image and if there is an issue deemed to be worthy of replicating for additional training data, then a description of the image and the text version of the issue are formed. The issue can be something the MLLM is not familiar with or is mostly not familiar with. In either event, there can be a determination that the MLLM does not know how to properly proceed once encountering the issue and can use more training data to alleviate this potential problem. In other words, developing training data augmented with the issue can make the MLLM better at reacting to the issue. The issue is augmented to ensure that multiple aspects of the issue are trained such as different lighting, setting, location, context, etc. so that the training data and model are robust.

The AI model (the MLLM) can learn to act appropriately based on a variety of different variations of the issue. For example, identifying a bear on the side of the road can indicate to drive through the area quickly while a bear in the center of the road can indicate to turn around.

The replication can be literal but does not have to be. Non-literal replications can replicate salient portions or concepts of the image that are useful for training the model in unusual driving circumstances. For example, scenes that include wildlife on the road or inclement weather conditions can be replicated in various ways by showing a wolf on the side of the road and a deer in the middle of the road. Alternatively, a tornado can be parallel to the road or hurricane winds blowing objects in front of the image.

A Vision/Visual Language Model (VLM) generates VLM description 106 from the issue in the closest matching background images. The matching can include using a nearest neighbor search in a language embedding space. Using those images, a description can be generated and those texts can be simulated using a text-to-image diffusion model. The diffusion-based method can apply a conditional input and use a mask control. The top-k nearest neighbors can be selected (e.g., k=5). In an embodiment of the present invention a third-party solution such as, e.g., Stable Diffusion™ 3, can receive VLM description 106 to form an image. Other third-party solutions are contemplated.

The images derived from VLM description 106 are then sent to LLM project manager 110 (LLM-controlled layout generation component). An open vocabulary detector can be used in VLM description 106 and the image derived therefrom to form bounding boxes and a confidence score for the image. The confidence score can be the same as, or different from the score used to evaluate the MLLM for related to the user text. Further the confidence score can be determined, evaluated, and/or computed by a system. The confidence score can be applied to the system for future actions. For instance, the confidence score can be compared to a threshold to determine whether a particular action can or cannot be performed. In some embodiments of the present invention the confidence score can determine when an image sufficiently is different from the ego (original) image, or the image accurately includes the issue intended to be augmented. In other words, the confidence score can be used to serve as a feedback value to re-prompt the model generate better corner case images. Other uses of the confidence score are also contemplated. The confidence score can be evaluated a set number of times such as, e.g., 10 steps can be used and if after 10 steps the confidence (score) is low, the image along with a low confidence will be output (e.g., “False”).

Format library 112 receives instructions which ensure that there is a repository of information for forming the image. If the quality is acceptable (is realistic and contains user requirement), the used text description is saved. Information in format library 112 can relate to the background image, the description of the background image, the prompted issue and object bounding boxes, etc. LLM project manager 110 can suggest changes to the image to be generated when appropriate. In other words, format library 112 includes information on all the variations that the generated background image can have. Format library 112 also receives a text input from issue finder 104.

Format library 112 then outputs information about the background images to image generator 114 which uses a diffusion inpainting pipeline to generate an image that fits the appropriate layout. The diffusion pipeline can include inputting the mask region (that can be edited) and the text condition, controlling the change in the mask region, and inserting any user required corner case features. Image generator 114 then uses Stable Diffusion™ 3 to generate the image. In an embodiment of the present invention, there can be a style transfer using Stable Diffusion™ 3 with low-rank Adaptation of LLMs (LoRA) finetuned with a dataset, e.g., nuScenes™. In other words, the content of one image and the style of another and the two are blended to produce a new image.

LLM self-correcting module 120 (multi-turn image editing component) receives bounding boxes from the open vocabulary detector, text issues, and images from image generator 114. LLM self-correcting module 120 then uses VLM Application Programming Interfaces (APIs) to evaluate the image. VLM APIs can be a GPT4o™ model that serves as LLM-as-a-judge. The input is the user query and the generated image, and the VLM API can evaluate if the image matches with user query and outputs a corresponding Boolean value. The system prompt of the VLM API can check if the generated image includes features from the user query. If all features are included, the output can be 1, otherwise the output can be 0. In some embodiments of the present invention, non-binary outputs are also contemplated.

If there is a match, then the image is output for training. A match can mean that the generated image includes the issue and the generated image is realistic. If the image is not a match, action APIs are employed. The action APIs can include adjusting the layout, adjusting the issue object context, adjusting hyperparameters of Stable Diffusion™ 3, etc. The non-matching image can then be sent back to LLM project manager 110 for another round of image generation that attempts to match again. This process can continue until the requirements for input issues and image quality are met or a preset number of iterations is reached. Once the requirements are met, the images can be classified as training data 130 for training a model, which can be used to train the model on the issue in the original image identified by issue finder 104.

While embodiments of the present invention mention autonomous driving, other applications are also contemplated such as identifying conditions (diseases, cancer, etc.) in medical images and scans.

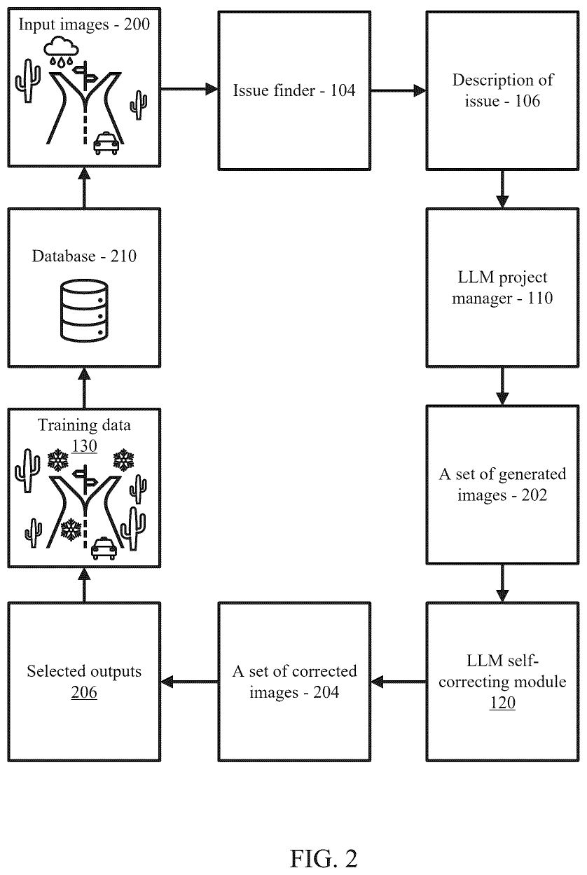

Referring to FIG. 2, a flow diagram illustrating the generation of training data is shown, in accordance with an embodiment of the present invention. Input images 200 are images of novel, unique, or rare situations. The situation depicted in input images 200 can include plausible but difficult to document situations. For example, in autonomous driving, viewing truck tire pop/explode can be very uncommon and potentially dangerous occurrences. The sound and sight can disorient drivers, make an obstacle on the road, or cause any number of other dangerous situations. Since the actual situation is so rare, capturing video documentation of tires popping (e.g., blown out tire) is even more rare. So, using each instance of a tire popping to generate new data is useful for training an autonomous vehicle for when a tire popping occurs on the road. Alternatively, precipitation in a desert can be rare and difficult to document and/or train an AV on.

With various backgrounds or other variations, the model can train a car to avoid or mitigate the dangers caused by the situation that the vehicle may not otherwise learn to perform. For example input image 200 can reflect a rainstorm in a desert. The augmentation of this training data can be reflected in training data 130 which reflects snow in a similar environment. In an embodiment of the present invention the road traveled can be the same or different. The background can also be the same or different. The AV can be trained to pull over onto the side of the road and wait for inclement weather to end and the roads to be safe. This option can be an option that is not contemplated by without training on this augmented training data, or a variety of other situations with bad driving conditions. AV in a region like southern California or another hot, desert region can be trained to travel on winding roads, in traffic, and near wildfires, but not snow or rain since those are rare there. Augmenting documentation of snow or rain in southern California is invaluable for AV training.

Outside of autonomous driving, the same techniques can be applied. When reviewing x-rays for cancer or other conditions, actual x-rays including the ailment can be rare, so training a model to detect the ailment can be difficult. Generating synthetic data for reflecting the ailment with new backgrounds (different bodies, etc.) can improve the ability of the model to detect the ailment.

Referring back to FIG. 2, input image 200 can be sent to issue finder 104 to identify issues. Multiple issues or no issues can also be detected in 104. The issues can be described in natural language or computer language as a VLM description 106. Once VLM description 106 is formed, LLM project manager 110 can form a generated set of images 202. The images in generated set of images 202 can be one or more images including the issue(s) raised in VLM description 106. The images can be modified to more accurately create plausible situations in LLM self-correcting module 120 which produces a set of corrected images 204.

From set of corrected images 204, some (or all) can be selected outputs 206 which are used in training of a model. Outputs 206 can then be classified as training images 130 which are used to train a model and entered into database 210 for future training and basis for further image generation. In other words, training images 130 stored in database 210 can be input images 200 for future image generation.

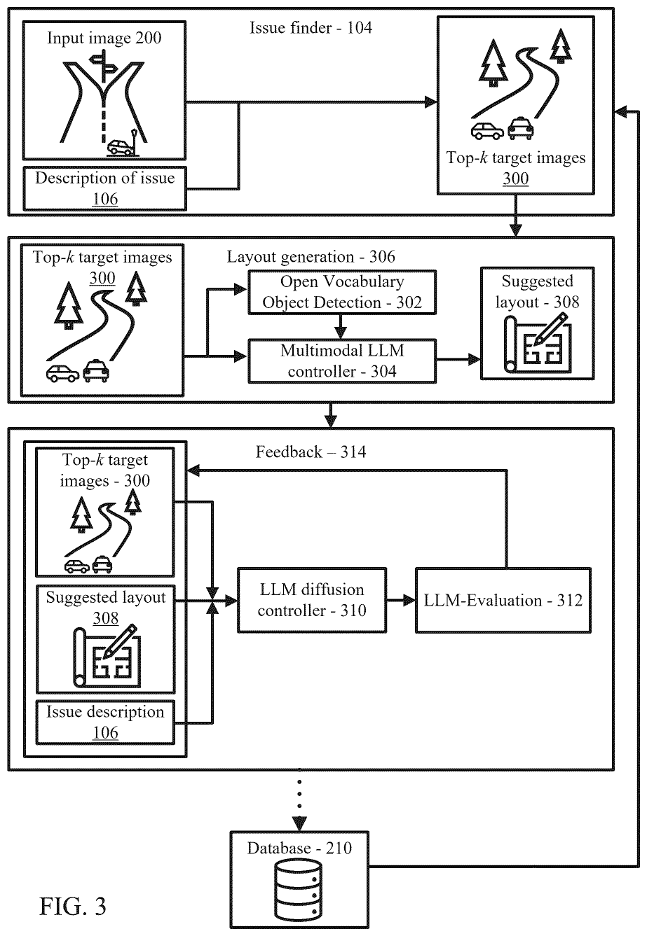

Referring to FIG. 3, a schematic diagram illustrating the image generation and regeneration process, in accordance with an embodiment of the present invention. Embodiments of the present invention can employ zero-shot learning to retrieve relevant images using third-party solutions such as, e.g, Intern VL-2™ in issue finder 104. From input images 200 and VLM description 106 top-k target images 300 are retrieved.

Using top-k target images 300, pseudo-labels can be assigned using open vocabulary object detection 302 for the layout in layout generation 306. These labels capture relevant scene layout information as well as bounding boxes and labels for traffic-related objects. Open vocabulary object detection (OVOD) 302 uses a VLM parser across general domains, along with open vocabulary detectors (OVD) to pseudo-label the scene layout information. The VLM parser extracts key object details, while the OVD enables text-guided object localization. Open vocabulary object detection 302 can use information akin to VLM description 106 (FIG. 1).

The VLM parser can include third-party implementations such as, e.g., GPT-4o® mini and Intern VL-2™, which can convert input images into lists of object names. The lists of names from OVOD 302 and top-k target images 300 can be input into MLLM controller 304 to form suggested layout 308. The OVD can be prompted with queries in the format: “image of a/an [attribute] [object name],” where the “attribute” and “object name” are derived from the VLM parser. The resulting bounding boxes are then organized into a structured list, formatted as [(“[object name] [#object ID]”, [top-left x, top-lefty, width, height])], for further processing. Other formats are also contemplated.

After extracting the layout from input images 200, MLLM controller 304 is leveraged with the multimodal chain-of-thought (CoT) reasoning capabilities of LLMs to design the final image composition. This approach enables the inclusion of rare objects and events to simulate driving corner cases. The final image can be akin to the image generated in image generator 114 (FIG. 1).

CoT reasoning of the LLM can be prompted with several operations to determine the optimal region for inserting the novel corner case including editing, merging, and splitting. Editing can be used when the task involves generating a novel object similar to an existing one in the scene. For instance, if the objective is to add a yellow construction vehicle, the LLM selects the largest road participant, such as a bus or truck, and modifies its bounding box to represent the new construction vehicle.

Merging is applied when the corner case involves multiple objects. In this case, the LLM identifies two adjacent objects in the layout and combines them into a larger bounding box. For example, if the task is to simulate a crash between a van and a car, the LLM merges the bounding boxes of these objects into a single bounding box to depict the accident.

Splitting occurs when a new object needs to be added to the scene, but no related objects are present in the layout. For instance, if the task is to introduce a pedestrian crossing near a bus station, the LLM creates a new bounding box for the pedestrian by dividing the existing bus station bounding box.

CoT reasoning can also include having the LLM recaption the background and corner case phrases into separate subprompts y^{base} and y^{region} where y^{base} is the context description for background in natural language, and y^{region} is the context description in natural language for the novel corner case that is wanted in the background.

After obtaining the LLM suggested layout 308 bounding box, feedback 314 can determine whether regeneration of the image is required. Within feedback 314 is LLM diffusion controller 310 which can split the input background image into several non-overlapping, complementary rectangular regions including a background region and region of interest. LLM diffusion controller (LLMDC) 310 inserts corner case components into the region of interest and then reinforces the conjunction of both background region and region of interest to maintain overall image coherence. A diffusion process can be summarized as:

$${x}_{t - 1} = LLMDC ( t , {x}_{t} , {x}^{′} , {y}^{layout} , {y}^{base} , {y}^{region} )$$

where t is the timestep, xₜ is diffusion model output at timestep t, x′ is the full background image input, y^{layout} is the layout including inserted/edited corner case objects. In each timestep, xₜ, y^{base}, y^{region} are input into the denoising diffusion transformer S_{θ} according to:

$${u}_{t}^{region} = {S}_{θ} ( {x}_{t} , {y}^{region} , {ϵ}_{t} , M ) , and {u}_{t}^{base} = {S}_{θ} ( {x}_{t} , {y}^{base} , {ϵ}_{t} , 1 - M )$$

where

$${u}_{t}^{region} and {u}_{t}^{base}$$

are the model outputs using positive prompt (corner case description) and negative prompt (original background description), respectively, ∈ₜ is the original noise, and M is a binary mask. For generated latent

$${u}_{t}^{region} and {u}_{t}^{base} ,$$

a rescale classifier-free guidance is used to enhance the smoothness of the boundary between edited region and background and solves image over-exposure issues associated with generating images.

$${u}_{t}^{′} = {u}_{t}^{base} + w ( {u}_{t}^{region} - {u}_{t}^{base} )$$

$${u}_{t - 1} = ϕ \cdot {u}_{t}^{′} \cdot \frac{σ ( {u}_{t}^{region} )}{σ ( {u}_{t}^{′} )} + ( 1 - ϕ ) \cdot {u}_{t}^{′}$$

where w is the guidance weight, φ is the rescale strength to balance the exposure of the output latent. Rescale strength aids in preventing over-exposure of the generated image. The output is refined by:

$$x ← {x}^{′} + ( 1 - M ) * ( β \cdot ( {x}^{′} - {x}_{T} ) + {x}_{T} ) \cdot M$$

where x_{T} is the output of the last diffusion step, β is a small weight (e.g., default weight value of 0.05) to balance smoothness of the boundary between the background and selected region.

To address hallucinations and inability to modify tokens often found in image generation models, a multi-round learning approach that incorporates feedback learning and Retrieval-Augmented Generation (RAG) is incorporated. This framework grounds the LLM in custom knowledge databases to ensure the generation of more accurate and contextually relevant responses. The approach is an iterative feedback loop. After LLM diffusion controller 310 uses top-k target images 300 and suggested layout 308 is generated to produce an edited image, the output is then evaluated by an additional verification model, LLM-Evaluation 312, which assesses the output compared to the user requirements. LLM-Evaluation 312 can be akin to LLM self-correcting module 120 (FIG. 1). The model provides feedback in natural language (or another form), which is fed back into the LLM's layout generator (LLM diffusion controller 310) alongside the initial image prompt (input images 200).

This feedback loop enables continuous improvement, if the verification model is satisfied with the result, the image and suggested layout 308 are in a database for future retrieval. Otherwise, the feedback serves as a guide for further refinement in the next round of generation. If the VLM (verification model, e.g., GPT-4o™) outputs “True,” the image description and layout can be saved to the RAG database with a key being the image description, bounding box information as a value of the layout format, and diffusion parameters as value(s). If the output is “False,” the VLM will also generate a text-based feedback to guide the next loop of generation. The process can be represented as follows:

$${y}^{feedback} ← LLM ( x , {y}^{region} , {y}^{layout} {y}^{hyper} )$$

where y^{layout} is the layout bounding box of background objects and suggested corner case objects and y^{hyper} is the diffusion model hyperparameters including strength, guidance scale, etc.

The output y^{feedback} includes suggestions for adjusting y^{layout} and y^{hyper}. For example, if the suggested bounding box is too small to encompass all key elements of a three car crash accident, the MLLM evaluator can provide a feedback as “Enlarge the bounding box and increase the strength of guidance scale hyperparameter to generate the crash accident with three cars.” With RAG and hyperparameter feedback from MLLM evaluator.

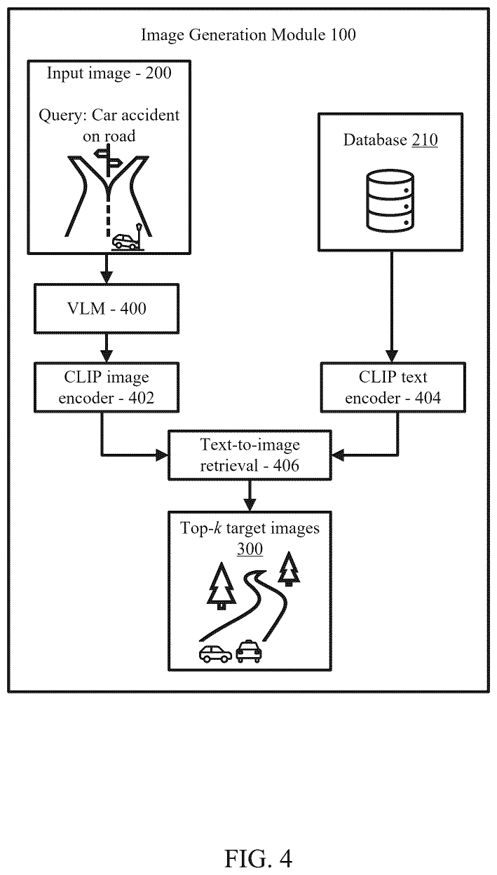

Referring to FIG. 4, a schematic diagram illustrating the image retrieval from input image 200 is shown in greater detail, in accordance with an embodiment of the present invention. Input images 200 are input into VLM 400 to determine the context of the image and the query to identify important, e.g., salient, portion of input images 200. CLIP image encoder 402 then embeds input images 200 into a latent space. Concurrently, database 210 identifies relevant images to the query. The relevant images can also be embedded in the same latent space from CLIP text encoder 404. The text embeddings and image embeddings are then matched. The embeddings are compared (matched) using cosine similarity to form text-to-image retrieval 406 pairs. The most matching pairs of images to the text form top-k target images 300. Other methods of comparing images are also contemplated such as, e.g., dot product, Euclidean Distance (L2), Manhattan Distance (L1), etc.

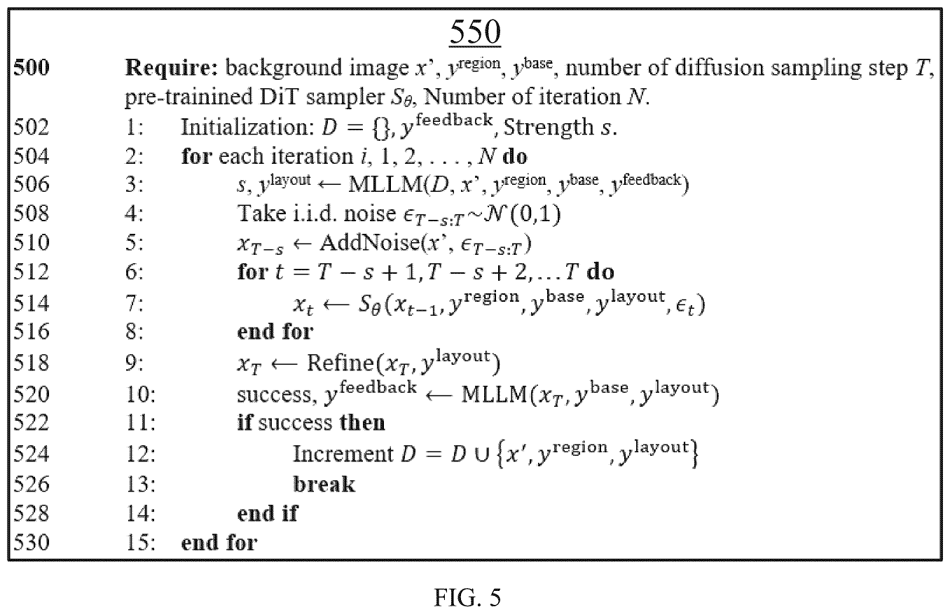

Referring to FIG. 5, an algorithm 550 for a regional diffusion transformer controller is shown, in accordance with an embodiment of the present invention. Algorithm 550 can correspond with LLM self-correcting module 120, which was also described in FIG. 3. The inputs of algorithm 550 (require 500) are background image x′, y^{region}, y^{base}, a number of diffusion sampling steps T, pre-trained diffusion transformer (DiT) sampler S_{θ}, and number of iteration N.

On line 1 of the code, (line 502), a dictionary D is initialized, as are y^{feedback}, and strength s. The strength, unlike the rescale strength, indicates how much of the original input is reflected in the output and how much is generated from the model. On line 2 of the code (line 504), a loop is initiated. The loop is a “for” loop that is for iterations up to the N. In the “for” loop, actions are performed in lines 3-14 (line 506, 508, 510, 512, 514, 516, 518, 520, 522, 524, 526, 528). On line 3 of the code (line 506), strength and y^{layout} are updated (assigned) values from an MLLM. The MLLM in on line 3 of the code (line 506) is a controller MLLM. The MLLM has D, x′, y^{region}, y^{base}, and y^{feedback} as inputs. On line 4 of the code (line 508), the Gaussian noise (∈) from independent and identically distributed (I.I.D.) random variables is taken. This goes from value of the number of diffusion sampling steps less (minus) the strength until the total number of diffusion sampling steps, from natural numbers from 0 to 1.

On line 5 of the code (line 510), the image indexed at the number of diffusion sampling steps less (minus) the strength until the total number of diffusion sampling steps is assigned noise as a function of the background image and the Gaussian noise from line 4 (line 508). On line 6 of the code (line 512), another “for” loop is initiated. The loop is for valued number of diffusion sampling steps minus the strength plus 1 (then plus 2, etc.) until the total number of diffusion sampling steps, perform the functions in line 7 of the code (line 514). On line 7 of the code (line 514), a value is assigned to the image of the iteration in the nested (e.g., inner) loop from the pre-trained DiT sampler based on the previous image from nested loops iteration, y^{region}, y^{base}, y^{layout} and the Gaussian noise. On line 8 of the code (line 516), the nested “for” loop is ended.

On line 9 of the code (line 518), the image from the final iteration (timestep) of the nested “for” loop is refined according to the final timestep image and the y^{layout}. On line 10 of the code (line 520), success and y^{feedback} are defined as outputs of the LLM when the MLLM has the inputs of the final timestep image, y^{base}, and y^{layout}. The MLLM in on line 10 of the code (line 520) is a evaluator MLLM. On line 11 of the code (line 522) a conditional term is initiated for success from line code in line 11 of the code (line 522). On line 12 of the code (line 524), based on the condition in line 11 of the code (line 522) being met, update the dictionary to be the dictionary with the union of the background image, y^{region}, and y^{layout}. On line 13 of the code (line 526), the conditional is broken. The conditional being broken can be defined as leaving the inner loop for the outer loop if the condition is met but not leaving the inner loop if the condition is not met. On line 14 of the code (line 528), the conditional is terminated. On line 15 of the code (line 530), the “for” loop is terminated.

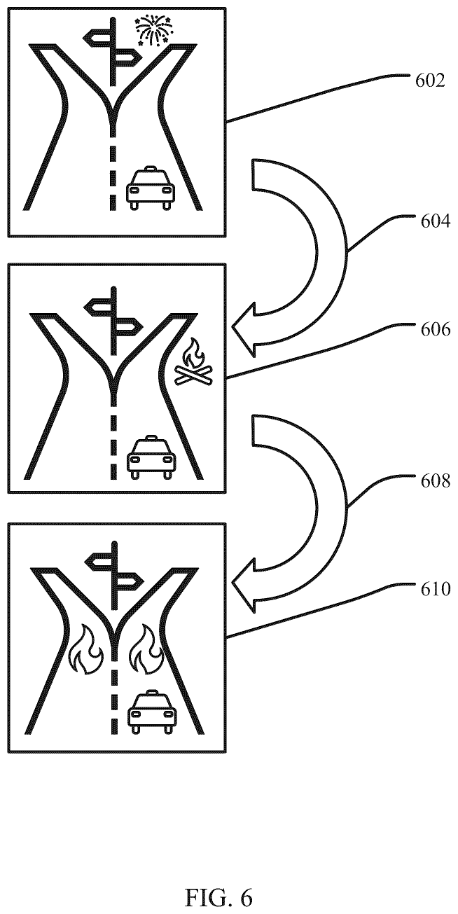

Referring to FIG. 6, a block diagram illustrating training image generation is shown, in accordance with an embodiment of the present invention. In image 602 there is a car on a road. Also in image 602 there can be a firework display. Since fireworks can be relatively rare to see while driving, an image including fireworks can be useful when training AV. The lights and sounds made during fireworks can create false positive reading on sensors of the car and can trigger the car to indicate that there is danger nearby, such as e.g., an explosion, or an emergency response vehicle with lights and a siren. Training with this data can be invaluable for differentiating between different types of lights and sounds so that the autonomous vehicle knowns how to respond appropriately in a given situation.

Not enough training can result in an autonomous vehicle ignoring the lights or sounds when there is an emergency or responding as if there is an emergency when in reality no emergency is present or reacting to lights and sounds when not necessary. Image 602 can be augmented to encapsulate the valuable/salient/useful/relevant/etc. portions of the image. With the augmented data, other images can be generated as variations of the original image. For example, the new images can be during daytime, when fireworks are much less likely to be seen, or the lights can be directed towards a different portion of the field of view than fireworks normally are. During augmentation 604, a new image 606 can be generated that has several similarities to image 602 such as a same or similar road.

Instead of fireworks in new image 606 like in image 602, the source of light and sound can be a campfire. The campfire can make sounds of cracking and popping and show lights flickering and smoke. In new image 606 the fire is on the side of the road and might be helpful in demonstrating a situation where the autonomous vehicle can be cautious since there are likely people around and those people can be in danger of being hit by the autonomous vehicle. Alternatively, new image 606 can be determined to not be useful. A campfire can be deemed a safe, controlled fire that is not helpful in learning how to deal with autonomous driving situations. In either case, where new image 606 is determined to be helpful or not helpful, the situation depicted can be augmented 608 to produce image 610. Augmenting 604 and augmenting 608 can utilize embodiments of the present invention and be saved for future use in a database such as a RAG database. In image 610, the fire is no longer a campfire on the side of the road, but rather a larger fire on the road. The fire can block traffic from proceeding past its flames. In this situation the sounds and lights can be more similar to the fireworks in image 602 and pose more of a threat that the autonomous vehicle can use to avoid future threats.

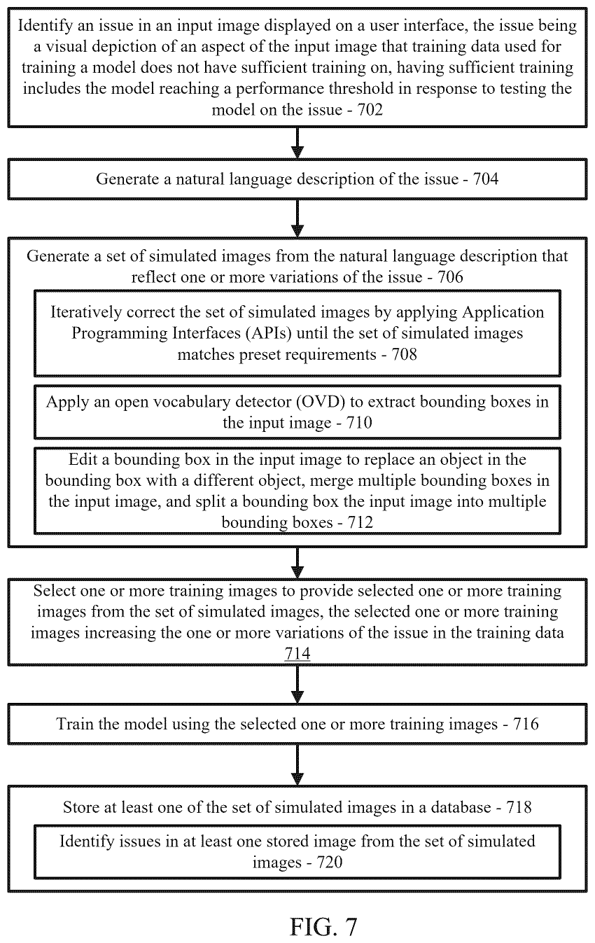

Referring to FIG. 7, a flow diagram illustrating a method for augmenting images for autonomous driving corner cases is illustrated, in accordance with an embodiment of the present invention. In block 702, an issue is identified in an input image. The issue can be displayed on a user interface. The issue can be a visual depiction of an aspect of the input image that training data used for training a model does not have sufficient training on, having sufficient training includes the model reaching a performance threshold in response to testing the model on the issue. In other words, the issue can be an unusual situation or object in an image that can be used to augment training data. The unusual situation can be a rare occurrence like a car crash or a car driving on the wrong side of the road. An unusual object can be something rarely documented such as a bear on the road. Other types of issues are also contemplated.

In block 704, a description of the issue in the input image is generated. The description can be in natural language or another form. The description can be iteratively generated if the initial description is not accurate or does not target the issue that is intended to be augmented. User feedback can guide or supplement the description, or the description can be entirely human based. Alternatively, the description can exclude user feedback.

In block 706, a set of simulated images from the natural language description that reflect one or more variations of the issue are generated. The set of simulated images can encompass the issue and can be reflected in variations of the issue. If the initial set of simulated images do not encompass or properly encompass the issue, the images can be iteratively re-generated to more effectively reflect the issue. This can happen a set number of times, or indefinitely. In block 708, the simulated images are iteratively corrected by applying Application Programming Interfaces (APIs) until the set of simulated images matches preset requirements.

In block 710, an open vocabulary detector can be applied to localize objects to extract bounding boxes in the input image. The open vocabulary detector can describe the issue in terms of nouns, adjectives, and verbs. In block 712, several methods can be used to aid in generating the set of simulated images. These methods can include editing a bounding box in the input image to replace an object in the bounding box with a different object, merging multiple bounding boxes in the input image, and splitting a bounding box the input image into multiple bounding boxes.

In block 714, one or more training images are selected to provide selected one or more training images from the set of simulated images. The selected one or more training images increase the one or more variations of the issue in the training data. The selected training images are used for training a model. The model can be used in autonomous vehicle usages (cars, boats, planes, etc.), disease recognition, agriculture (for identifying droughts, pests, crop health, etc.), manufacturing (for identifying defects), etc. In block 716, the model is trained using the selected one or more training images. The training images can be used to improve the model when comparing to a performance threshold for the issue. Any number of artificial intelligence models can be trained including artificial neural networks (ANNs), autonomous vehicles, computer vision, etc. In block 718, at least one of the set of simulated images are stored in a database. The database can be a RAG database or a database of another type. In block 720, issues can be identified in at least one of the stored images from the at least one of the set of simulated images. In other words, new issues can be identified and augmented using the augmented training data.

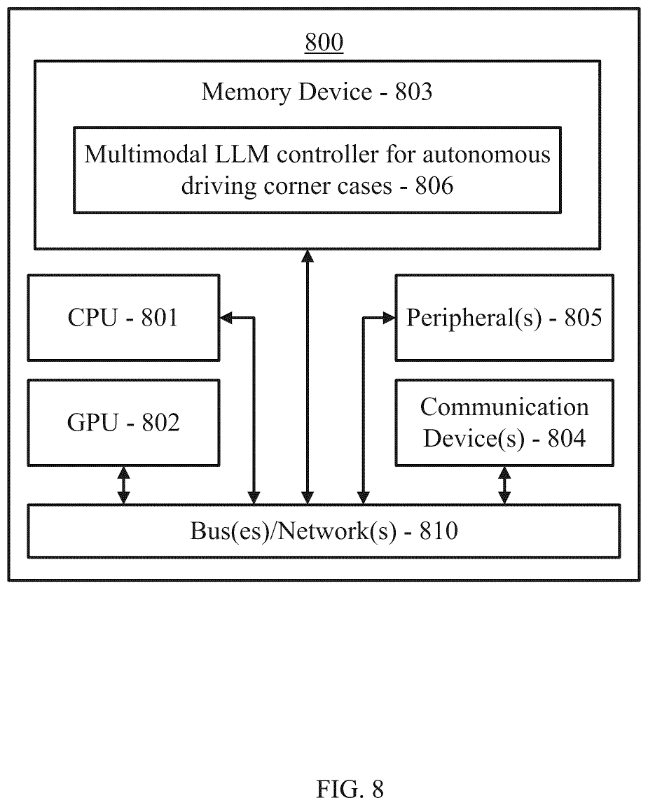

Referring to FIG. 8, a schematic diagram is shown for an exemplary processing system 800, in accordance with an embodiment of the present invention. Processing system 800 can augment data using a multimodal LLM controller for autonomous driving corner cases. Processing system 800 includes a set of processing units (e.g., CPUs) 801, a set of GPUs 802, a set of memory devices 803, a set of communication devices 804, and a set of peripherals 805. CPUs 801 can be single or multi-core CPUs. The GPUs 802 can be single or multi-core GPUs. The one or more memory devices 803 can include caches, RAMs, ROMs, and other memories (flash, optical, magnetic, etc.). The communication devices 804 can include wireless and/or wired communication devices (e.g., network (e.g., Wi-Fi®, etc.) adapters, etc.). The peripherals 805 can include a display device, a user input device, a printer, an imaging device, and so forth. The user can enter in specific issues or augmentation techniques to be augmented. Additionally, the user can enter descriptions of the issues in natural language or another form using peripherals 805. Alternatively, the MLLM can decide to augment the data automatically using AI. The automatic data augmentation can apply techniques known in the art to vary the representation of the issue. A combination of user directed and AI directed data augmentation is also contemplated such as, e.g., AI recommendations for user prompting, or AI augmentation that can be corrected by the user. Elements of processing system 800 are connected by one or more buses or networks (collectively denoted by the figure reference numeral 810).

In an embodiment of the present invention, memory devices 803 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 803 store program code or software 806 for a multimodal LLM controller for autonomous driving corner cases. Software 806 can implement embodiments of the present invention to augment image for training data of corner cases. The software can receive and augment images to vary the features within them. The augmentation can be to capture salient portions in different situations. Software 806 can iteratively augment images if the not augmented correctly and save images for future augmentation. The augmentation software 806 includes identifying an issue in an input image displayed on a user interface, the issue being a visual depiction of an aspect of the input image that training data used for training a model does not have sufficient training on, having sufficient training includes the model reaching a performance threshold in response to testing the model on the issue and generating a natural language description of the issue. The augmentation software 806 can also include generating a set of simulated images from the natural language description that reflect one or more variations of the issue, selecting one or more training images to provide selected one or more training images from the set of simulated images, the selected one or more training images increasing the one or more variations of the issue in the training data, and training the model using the selected one or more training images. The memory devices 803 can store program code for implementing one or more functions of the systems and methods described herein.

Of course, the processing system 800 may also include other elements (not shown), as readily contemplated by one of skill in the art, as well as omitting certain elements. For example, various other input devices and/or output devices can be included in processing system 800, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 800 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 800.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed. Lists of embodiments and other explanations of technical details are intended to be non-limiting. While technical details can be recited with regards to an embodiment of the present invention, those same technical details can be applied to other embodiments. For example, it is contemplated that an embodiment listing elements X, Y, and Z, and a second embodiment listing elements M, N, O and be combined to create a recited or non-recited embodiment X, Y, and N; or X, Y, Z, and M, etc., or any combination thereof.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims. Embodiments of the present invention can include features depicted and described in alternative embodiments and may be excluded for the sake of brevity and clarity. Lists of embodiments and other explanations of technical details are intended to be non-limiting.

What is claimed is:

1. A method comprising:
identifying an issue in an input image displayed on a user interface, the issue being a visual depiction of an aspect of the input image that training data used for training a model does not have sufficient training on, having sufficient training includes the model reaching a performance threshold in response to testing the model on the issue;
generating a natural language description of the issue;
generating a set of simulated images from the natural language description that reflect one or more variations of the issue;
selecting one or more training images to provide selected one or more training images from the set of simulated images, the selected one or more training images increasing the one or more variations of the issue in the training data; and
training the model using the selected one or more training images.

2. The method of claim 1, wherein generating the set of simulated images further comprises:
iteratively correcting the set of simulated images by applying Application Programming Interfaces (APIs) until the set of simulated images matches preset requirements.

3. The method of claim 1, wherein generating the set of simulated images from the natural language description further comprises:
extracting bounding boxes in the input image by applying an open vocabulary detector (OVD) to localize objects.

4. The method of claim 1, further comprising:
storing at least one of the set of simulated images in a database.

5. The method of claim 4, further comprising:
identifying issues in at least one stored image from the set of simulated images.

6. The method of claim 1, wherein generating the set of simulated images further comprises:
editing a bounding box in the input image to replace an object in the bounding box with a different object.

7. The method of claim 1, wherein generating the set of simulated images further comprises:
merging multiple bounding boxes in the input image.

8. The method of claim 1, wherein generating the set of simulated images further comprises:
splitting a bounding box the input image into multiple bounding boxes.

9. The method of claim 1, wherein generating the set of simulated images further comprises:
changing a background and lighting of the set of simulated images.

10. A system comprising:
a processor; and
a memory storing computer-readable instructions that, when executed by the processor, cause the system to:
identify an issue in an input image displayed on a user interface, the issue being a visual depiction of an aspect of the input image that training data used for training a model does not have sufficient training on, having sufficient training includes the model reaching a performance threshold in response to testing the model on the issue;
generate a natural language description of the issue;
generate a set of simulated images from the natural language description that reflect one or more variations of the issue;
select one or more training images to provide selected one or more training images from the set of simulated images, the selected one or more training images increasing the one or more variations of the issue in the training data; and
train the model using the selected one or more training images.

11. The system of claim 10, wherein causing the system to generate the set of simulated images further includes causing the system to:
iteratively correct the set of simulated images by applying Application Programming Interfaces (APIs) until the set of simulated images matches preset requirements.

12. The system of claim 10, wherein causing the system to generate the set of simulated images from the natural language description further includes causing the system to:
extract bounding boxes in the input image by applying an open vocabulary detector (OVD) to localize objects.

13. The system of claim 10, further causing the system to:
store at least one of the set of simulated images in a database.

14. The system of claim 13, further causing the system to:
identify issues in at least one stored image from the set of simulated images.

15. The system of claim 10, wherein causing the system to generate the set of simulated images further includes causing the system to:
edit a bounding box in the input image to replace an object in the bounding box with a different object.

16. The system of claim 10, wherein causing the system to generate the set of simulated images further includes causing the system to:
merge multiple bounding boxes in the input image.

17. The system of claim 10, wherein causing the system to generate the set of simulated images further includes causing the system to:
split a bounding box the input image into multiple bounding boxes.

18. A computer program product comprising a non-transitory computer-readable storage medium containing computer program code, the computer program code when executed by one or more processors causes the one or more processors to perform operations, the computer program code comprising instructions to:
identify an issue in an input image displayed on a user interface, the issue being a visual depiction of an aspect of the input image that training data used for training a model does not have sufficient training on, having sufficient training includes the model reaching a performance threshold in response to testing the model on the issue;
generate a natural language description of the issue;
generate a set of simulated images from the natural language description that reflect one or more variations of the issue;
select one or more training images to provide selected one or more training images from the set of simulated images, the selected one or more training images increasing the one or more variations of the issue in the training data; and
train the model using the selected one or more training images.

19. The computer program product of claim 18, wherein causing the processor to generate the set of simulated images further includes causing the processor to:
iteratively correct the set of simulated images by applying Application Programming Interfaces (APIs) until the set of simulated images matches preset requirements.

20. The computer program product of claim 18, wherein causing the processor to generate the set of simulated images from the natural language description further includes causing the processor to:
extract bounding boxes in the input image by applying an open vocabulary detector (OVD) to localize objects;
store at least one of the set of simulated images in a database; and
identify issues in at least one stored image from the set of simulated images.
